(19) United States
(12) Patent Application Publication
(10) Pub. No.: US 2013/0017436 A1
(43) Pub. Date: Jan. 17, 2013

(54) POWER SOURCE APPARATUS AND VEHICLE EQUIPPED WITH THE POWER SOURCE APPARATUS

(71) Applicant: Masao KUME, Osaka (JP)

(72) Inventor: Masao KUME, Osaka (JP)

(21) Appl. No.: 13/545,384

(22) Filed: Jul. 10, 2012

(30) Foreign Application Priority Data
Jul. 12, 2011 (JP) 2011-154179

(51) Int. Cl. H01M 2/10

(52) U.S. Cl. 429/159; 429/158

(57) ABSTRACT

The power source apparatus has battery units 2 connected in series or parallel with bus-bars 6. Each battery unit 2 is made up of a plurality of connected battery cells 1. Each bus-bar 6 is metal plate formed with mutually perpendicular upright planar region(s) 6x and lateral planar region(s) 6y connected between connecting terminals 6a at both ends. Lateral and up and down relative vibration between battery units 2 connected to the connecting terminals 6a is absorbed by the upright planar region(s) 6x and lateral planar region(s) 6y.

### BACKGROUND OF THE INVENTION

1. Field of the Invention

The present invention relates to a power source apparatus with a plurality of battery units or battery blocks connected in series and/or parallel to increase output, and in particular, to a power source apparatus that supplies power to a motor to drive a vehicle, to a power source apparatus charged by a renewable energy source such as solar cells or by late-night (low-rate) electric power, to a power source apparatus optimized for use as a backup power supply in the event of power outage, and to a vehicle equipped with the power source apparatus.

2. Description of the Related Art

A power source apparatus has been developed with a plurality of battery units connected in series to increase output. (Refer to Japanese Laid-Open Patent Publication 2010-157451.)

As shown in FIG. 1, the cited power source apparatus has four battery units 102 housed in an external casing 109 with adjacent battery units 102 connected in series by bus-bars 106. Each battery unit 102 has a plurality of battery cells 101 stacked between endplates 104 and held together by fastening material 105. The battery cells 101 of a battery unit 102 are connected in series by lead-plates (not illustrated). The power source apparatus has four battery units 102 arrayed in rows and columns within a horizontal plane and mounted inside the external casing 109. Battery units 102 are connected by metal plate bus-bars 106 to connect adjacent battery units 102 together.

In a power source apparatus with a plurality of battery units 102 connected by bus-bars 106 as shown in FIG. 1, relative vibration between battery units 102 applies bending stress to the bus-bars 106. This raises concern for detrimental effects such as bus-bar 106 damage or break-off. Damage due to bus-bar vibration can be alleviated by using many small-diameter wires bundled together in a pliable twisted-wire configuration. Many small-diameter wires are grouped together to give the twisted-wire low electrical resistance, and solderless terminals are crimped onto both ends for connection to battery unit output terminals. The solderless terminals are pressed-onto and crimp-attached to the twisted-wire. In a bus-bar with this structure, processes such as corrosion in the connecting region between the twisted-wire and a crimped solderless terminal can cause contact resistance to increase over time. This drawback can be avoided by crimping the solderless terminals onto the twisted-wire, soldering the crimped region, and then coating the crimped region with wax. However, fabrication of this type of bus-bar is complex and has the drawback that the parts cost becomes extremely expensive.

The present invention was developed with the object of correcting the drawbacks described above. Thus, it is a primary object of the present invention to provide a power source apparatus and vehicle equipped with the power source apparatus that can reliably prevent bus-bar damage and open-circuit while employing a structure that allows the bus-bars to be inexpensively manufactured in quantity.

### SUMMARY OF THE INVENTION

The power source apparatus of the present invention connects battery units 2, which are made up of a plurality of connected battery cells 1, in series or parallel with bus-bars 6. Each bus-bar 6 is metal plate formed with mutually perpendicular upright planar region(s) 6x and lateral planar region(s) 6y connected between connecting terminals 6a at both ends. The upright planar region(s) 6x and lateral planar region(s) 6y absorb lateral and up and down relative vibration between battery units 2 connected to the connecting terminals 6a.

The power source apparatus described above has the characteristic that bus-bar damage and open-circuit can be reliably prevented with a structure that allows the bus-bars to be inexpensively manufactured in quantity. This is because the power source apparatus described above utilizes metal plates, which are worked to form connected upright planar regions and lateral planar regions, as bus-bars that connect the battery units together. Since the metal plates can be wide with a large cross-sectional area, electrical resistance can be reduced. Consequently, for battery units charged and discharged by high currents, this has the characteristic that power consumption wasted by the bus-bars can be reduced. Incidentally, two adjacent battery units connected by bus-bars can vibrate up and down and laterally relative to each other. Since bus-bars provided in the power source apparatus of the present invention are metal plates worked to form connected upright planar regions and lateral planar regions, the upright planar regions and lateral planar regions can absorb both lateral and up and down vibration. This is because the property of folded (bent) metal plate that makes it easier to bend in the direction of the folded surfaces is utilized to absorb lateral and up and down vibration. Specifically, in FIGS. 4 and 5, metal plate upright planar regions 6x bend easily due to lateral vibration in the direction shown by arrow X, and the lateral planar region 6y bends easily due to up and down vibration in the direction shown by arrow Y.

In the power source apparatus of the present invention, a bus-bar 6 can be formed with upright planar regions 6x joined to both ends of a lateral planar region 6y, and the ends of the upright planar regions 6x can be joined to the lateral planar region 6y and the connecting terminals 6a, which lie in planes parallel to the lateral planar region 6y. In this power source apparatus, the lateral planar region established in the mid-region of the bus-bar absorbs up and down vibration, and the upright planar regions established on both sides of the mid-region absorb lateral vibration. This configuration can effectively prevent bus-bar damage and open-circuit due to up and down and lateral relative vibration between battery units.

In the power source apparatus of the present invention, a bus-bar 6 can be worked to bend it in a zigzag shape having zigzag regions 6z. In this power source apparatus, since the zigzag region can absorb spatial variation in the lengthwise direction, vibration that results in mutual approach and separation of the battery units can be absorbed in addition to lateral and up and down vibration. Specifically, the bus-bars can effectively absorb vibration between adjacent battery units in three dimensions to effectively prevent bus-bar damage and open-circuit.

In the power source apparatus of the present invention, a bus-bar 6 can be processed to bend it in a twisted manner with alternating upright planar regions 6x and a lateral planar region 6y. In this power source apparatus, since metal plates are processed by twisting, bus-bars can be simply, easily, and inexpensively manufactured in quantity, and damage due to relative vibration between battery units can be prevented.

In the power source apparatus of the present invention, the bus-bars 6 can be any of the metals such as copper, copper alloy, silver, or silver alloy.

The power source apparatus of the present invention can be provided with an external casing 9 that holds a plurality of battery units 2, and the battery units 2 can be mounted on a base-plate 9a in the external casing 9.

The power source apparatus of the present invention can be used as the power source to supply electric power to a motor that drives a vehicle. The power source apparatus described above can reliably prevent detrimental effects caused by vehicle vibration such as bus-bar damage or break-off. In addition, the power source apparatus has the characteristic that bus-bar power loss and heat generation can be reduced while discharging the batteries with high current during vehicle acceleration or charging the batteries with high current derived from the energy of regenerative braking. This is because electrical resistance can be reduced by fabricating the bus-bars from metal plate. Since bus-bar heat generation and power loss are proportional to the product of the electrical resistance and the square of the current, heat generation and power loss can be reduced by reducing the electrical resistance.

The vehicle of the present invention is provided with any one of the power source apparatus cited above. The above and further objects of the present invention as well as the features thereof will become more apparent from the following detailed description to be made in conjunction with the accompanying drawings.

### BRIEF DESCRIPTION OF THE DRAWINGS

FIG. 1 is an oblique view showing an array of battery units in a prior art power source apparatus;

FIG. 2 is an abbreviated plan view showing the structure of a power source apparatus for an embodiment of the present invention;

FIG. 3 is a vertical cross-section in the lengthwise direction of the power source apparatus shown in FIG. 2;

FIG. 4 is an oblique view showing one example of a bus-bar;

FIG. 5 is a plan view of the bus-bar shown in FIG. 4;

FIG. 6 is a plan view of the bus-bar shown in FIG. 4 in the unfolded state;

FIG. 7 is an oblique view showing another example of a bus-bar;

FIG. 8 is a plan view of the bus-bar shown in FIG. 7;

FIG. 9 is a plan view of the bus-bar shown in FIG. 7 in the unfolded state;

FIG. 10 is an oblique view showing another example of a bus-bar;

FIG. 11 is an oblique view showing another example of a bus-bar;

FIG. 12 is an oblique view showing another example of a bus-bar;

FIG. 13 is an oblique view showing another example of a bus-bar;

FIG. 14 is an oblique view showing an example of a configuration for using the bus-bar shown in FIG. 12;

FIG. 15 is an oblique view showing an example of a configuration for using the bus-bar shown in FIG. 13;

FIG. 16 is an exploded oblique view showing the battery cell and spacer stacking configuration for the power source apparatus shown in FIG. 2;

FIG. 17 is an enlarged cross-section view showing the connecting structure of a battery unit and bus-bar;

FIG. 18 is an enlarged cross-section view showing another example of a battery unit and bus-bar connecting structure;

FIG. 19 is a block diagram showing an example of a hybrid vehicle, which is driven by a motor and an engine, equipped with a power source apparatus;

FIG. 20 is a block diagram showing an example of an electric vehicle, which is driven by a motor only, equipped with a power source apparatus; and

FIG. 21 is a block diagram showing an example of a power source apparatus used in a power storage application.

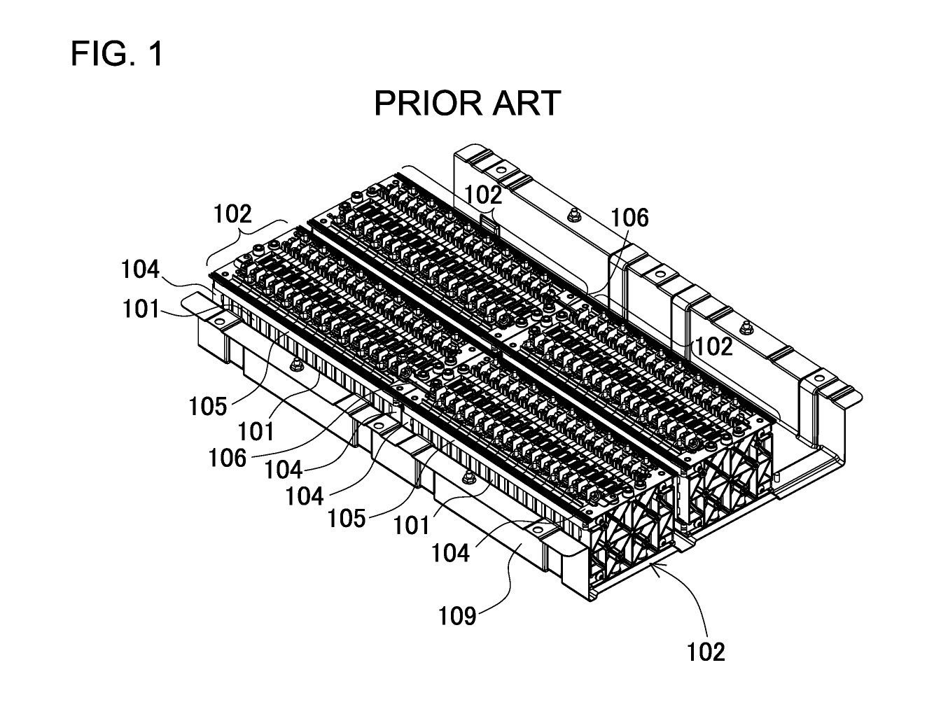

### DETAILED DESCRIPTION OF THE EMBODIMENTS

The following describes embodiments of the present invention based on the figures. However, the following embodiments are merely specific examples of a power source apparatus and vehicle equipped with the power source apparatus representative of the technology associated with the present invention, and the power source apparatus and vehicle of the present invention are not limited to the embodiments described below. It should be noted that components cited in the claims are in no way limited to the components indicated in the embodiments.

The power source apparatus of the present invention has a plurality of battery units connected together to increase output, and is used, in particular, as a power source apparatus carried in an electric powered vehicle such as a hybrid vehicle or electric vehicle to supply power to the driving motor to drive the vehicle. Or, it is used as a power source apparatus that is charged by a renewable energy source such as solar cells or by late-night (low-rate) electric power. Or, it is used as a power source apparatus that is a backup power supply for power outages.

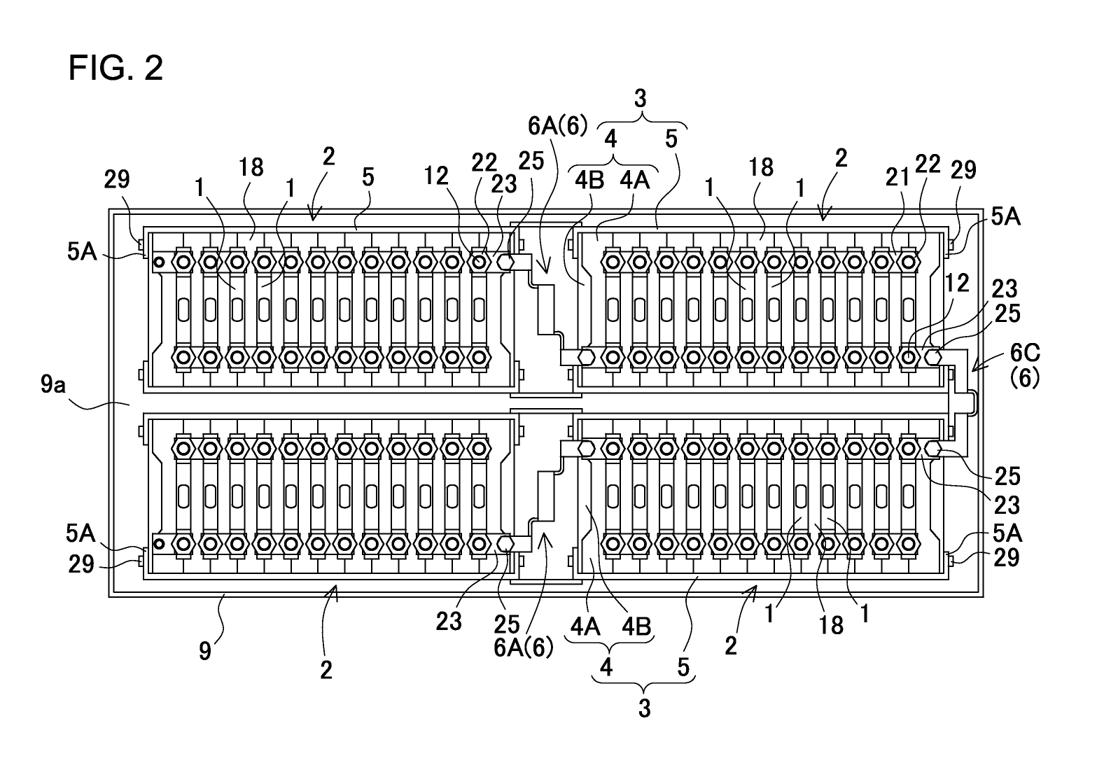

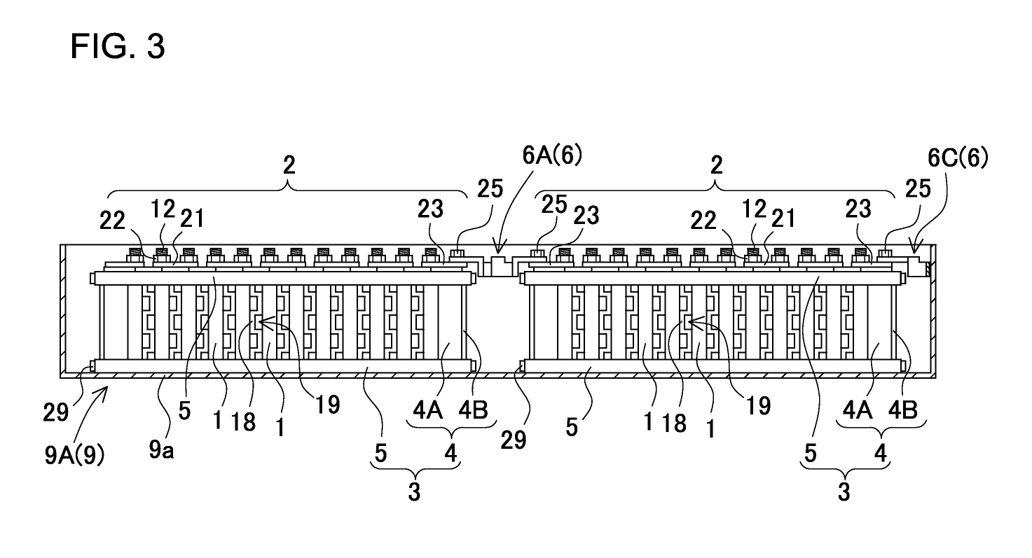

The power source apparatus shown in FIGS. 2 and 3 has a plurality of battery units 2 connected in series by bus-bars 6. The power source apparatus in these figures has four battery units 2 connected in series by bus-bars 6. Since this power source apparatus has the battery units 2 connected in series, it can have a high output voltage. However, the power source apparatus of the present invention can also have a plurality of battery units connected in parallel to increase the output current. Further, a plurality of battery units can also be connected in series and parallel for high output voltage and high output current.

The power source apparatus in FIG. 2 has four battery units 2 mounted on the base-plate 9a of an external casing 9. Two battery units 2 are arranged in a straight-line and connected in series by bus-bars 2. Further, two of these straight-line rows are disposed adjacently and connected in series by bus-bars 6 to connect all the battery units 2 in series via bus-bars 6.

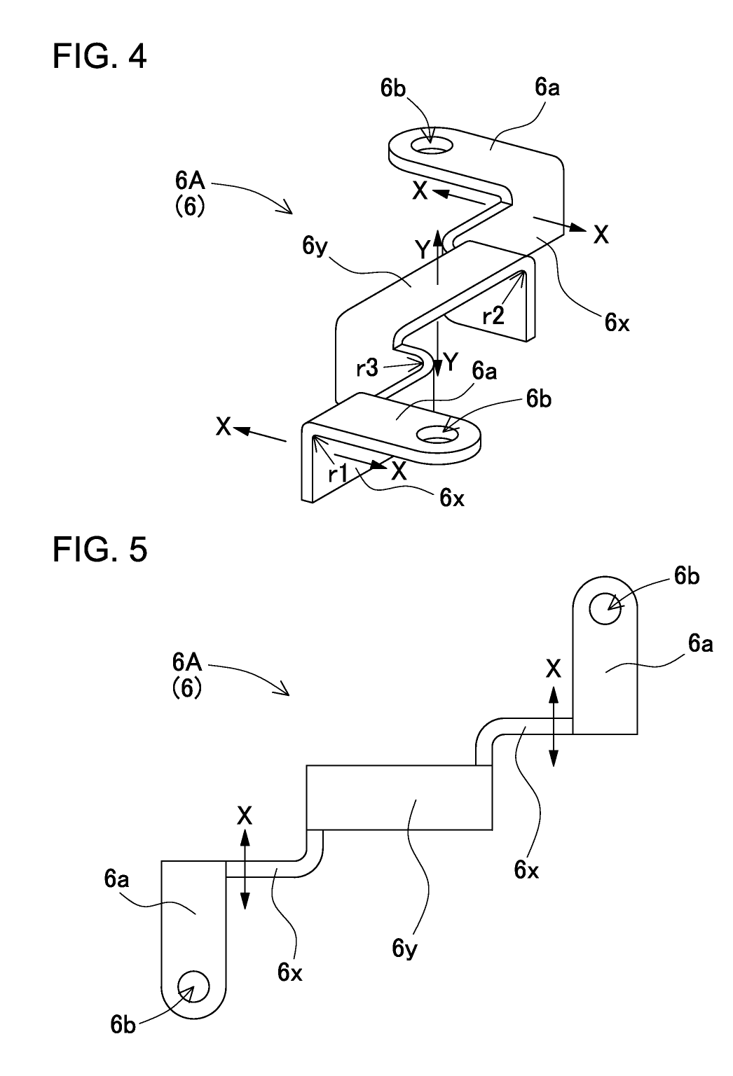

As shown in FIGS. 4-15, a bus-bar 6 is a metal plate 7 worked into a shape that has connecting mutually perpendicular upright planar region(s) 6x and lateral planar region(s) 6y. The upright planar region(s) 6x and lateral planar region(s) 6y act to absorb lateral and up and down relative vibration between battery units 2 connected with the bus-bar 6 connecting terminals 6a. The bus-bar 6 is provided with through-holes 6b in the connecting terminals 6a at both ends. As shown in FIGS. 2 and 3, a bus-bar 6 is connected to the battery units 2 by inserting bolts 25 through the through-holes 6b. The width and thickness dimensions of the metal plate 7 for the bus-bar 6 are optimized depending on the amount of power supplied to the load. For example, a bus-bar 6 in a power source apparatus for an automotive application uses metal plate 7 with a thickness of 1 mm to 3 mm and a width of 1 cm to 3 cm. In a power source apparatus that supplies power to a load and is charged by a renewable energy source or late-night power, the metal plate 7 width and thickness are also determined considering the amount of power supplied to the load. For example, a bus-bar 6 in a power source apparatus used in this type of application has a thickness of 0.5 mm to 3 mm and a width of 1 cm to 3 cm. Metal with low electrical resistance and superior pliability is used as the metal plate. For example, copper plate with a metal plated surface can be used as the metal plate. However, any metal plate with low electrical resistance and superior pliability such as copper alloy, nickel, or nickel alloy can be used as the metal plate for a bus-bar 6.

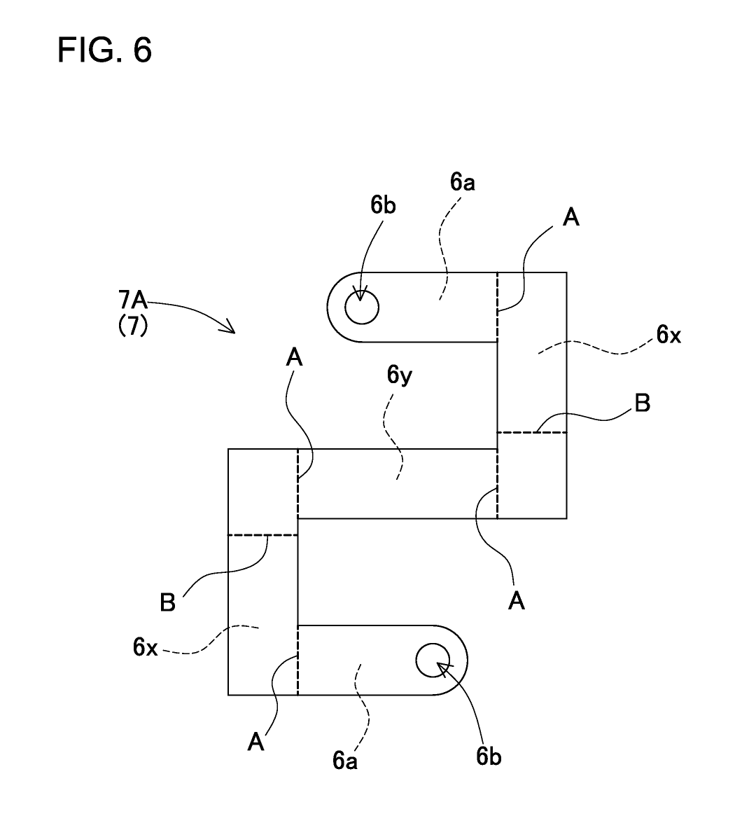

Bus-bars 6 are manufactured by cutting metal plate to a given shape and bending it into the bus-bar 6 configuration. The bus-bar 6A shown in FIGS. 4 and 5 has upright planar regions 6x joined to both ends of a lateral planar region 6y, and the ends of the upright planar regions 6x are joined to the lateral planar region 6y and the connecting terminals 6a, which lie in planes parallel to the lateral planar region 6y. The upright planar regions 6x joined to both ends of the lateral planar region 6y extend in opposite directions from the lateral planar region 6y and the connecting terminals 6a connected at the end of each upright planar region 6x point in opposite directions. Specifically, in the plan view shown in FIG. 5, the bus-bar 6A is formed with 180° (2-fold) rotational symmetry. FIG. 6 shows the bus-bar 6A in the unfolded state. In this unfolded view, each location indicated by a broken line is bent into a right angle to form the bus-bar 6A shown in the oblique view of FIG. 4. Specifically, the metal plate 7A shown in the unfolded view of FIG. 6 is bent at the broken lines A to fold the upright planar regions 6x downward (into the page of FIG. 6 to form ridges on the upper surface) with respect to the lateral planar region 6y and the connecting terminals 6a, and folds at the broken lines B are made in the opposite direction (to form valleys) to produce the bus-bar 6A shown in the oblique view of FIG. 4. In addition, the degree of vibration absorption in the lateral and up and down directions can be adjusted by adjusting the radius of curvature of each of the bends (folds) in the bus-bar 6A. In the bus-bar 6A shown in FIG. 4, the radius of curvature (r3) of the bends made at broken lines B (in FIG. 6) are made larger than the radii of curvature (r1), (r2) of the bends made at broken lines A (in FIG. 6) to improve absorption of lateral vibration. When the connecting terminals 6a of this bus-bar 6A are attached to battery units 2 in a horizontal disposition, the lateral planar region 6y lies in a horizontal plane and the upright planar regions 6x lie in vertical planes. Since each lateral planar region 6y and upright planar region 6x are disposed orthogonally, one planar region will lie in a vertical plane if the other lies in a horizontal plane. Similarly, if either a lateral planar region or upright planar region is inclined relative to horizontal, then the other planar region will also be inclined at an oblique angle. However, the lateral planar region and upright planar region are always at a right angle.

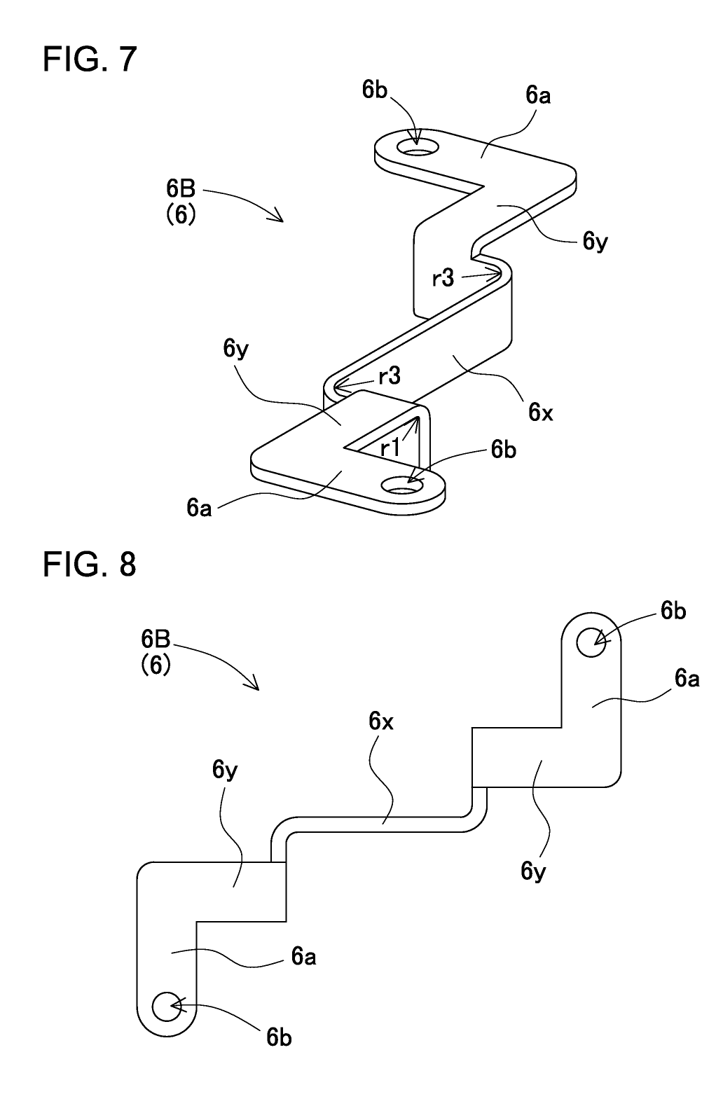

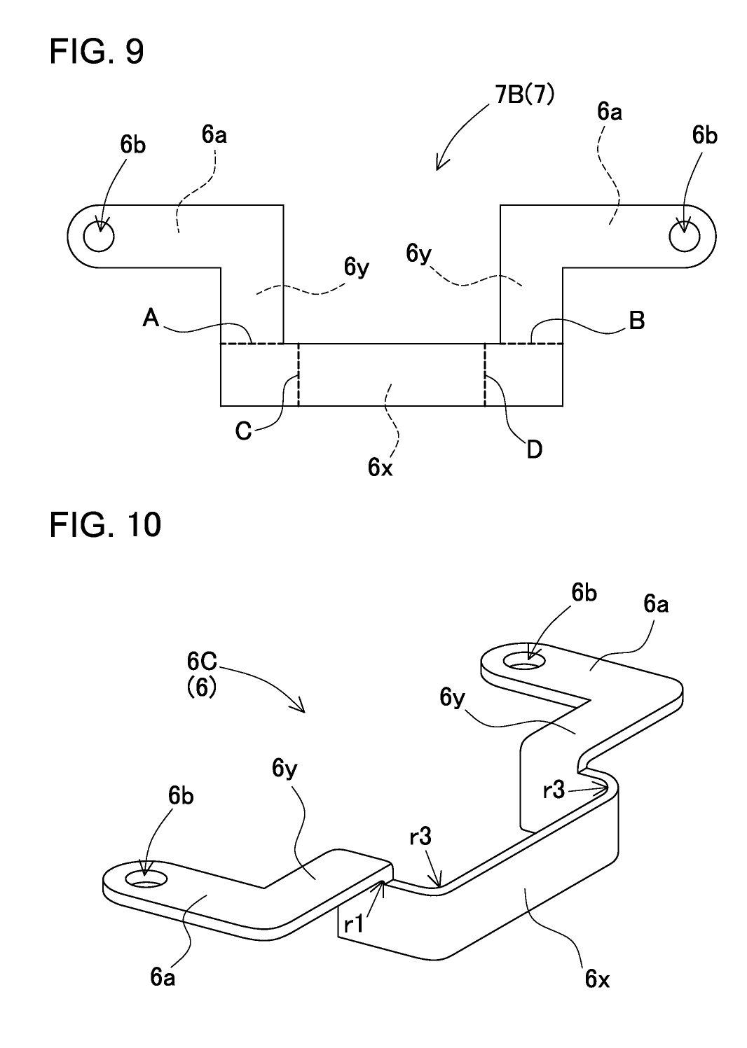

The bus-bar 6B shown in FIGS. 7 and 8 have lateral planar regions 6y joined to both ends of a upright planar region 6x, and the ends of the lateral planar regions 6y are the connecting terminals 6a. FIG. 9 shows the bus-bar 6B in the unfolded state. In this unfolded view, each location indicated by a broken line is bent into a right angle to form the bus-bar 6B shown in the oblique view of FIG. 7. Specifically, the metal plate 7B shown in the unfolded view of FIG. 9 is bent (into the page of FIG. 9) at the broken lines A and D to form ridges (on the upper surface), and bent in the opposite direction to form valleys at the broken lines B and C to produce the bus-bar 6B shown in the oblique view of FIG. 7. In this bus-bar 6B, the unfolded metal plate 7B shown in FIG. 9 is bent in opposite directions at broken lines A and B to form lateral planar regions 6y at both ends of the upright planar region 6x, and the upright planar region 6x is bent in opposite directions at broken lines C and D translating the lateral planar regions 6y and connecting terminals 6a that point in opposite directions. Specifically, in the plan view shown in FIG. 8, the bus-bar 6B is formed with 180° (2-fold) rotational symmetry. In addition, the degree of vibration absorption in the lateral and up and down directions is adjusted by adjusting the radius of curvature of each of the bends (folds) in the bus-bar 6B. In the bus-bar 6B shown in FIG. 7, the radius of curvature (r3) of the bends made at broken lines C and D (in FIG. 9) are made larger than the radius of curvature (r1) of the bends made at broken lines A and B (in FIG. 9) to improve absorption of lateral vibration. For this bus-bar 6B as well, when the connecting terminals 6a are attached to battery units 2 in a horizontal disposition, the lateral planar regions 6y lie in horizontal planes and the upright planar region 6x lies in a vertical plane.

Here, the bus-bar 6B shown in FIGS. 7 and 8 has connecting terminals 6a established at both ends that point in opposite directions. However, as shown in FIG. 10, a bus-bar can also have connecting terminals 6a that point in the same direction at both ends. The bus-bar 6C shown in FIG. 10 can also be formed from the unfolded metal plate 7B shown in FIG. 9 by making right angle bends along the broken lines, but the bending directions are different than those for the bus-bar 6B in FIG. 7. This bus-bar 6C is formed in the shape shown in the oblique view of FIG. 10 by bending the metal plate 7B in FIG. 9 to form ridges at the broken lines A and B (folding the upright planar region 6x downward into the page of FIG. 9), and making opposite folds to form valleys at the broken lines C and D. Namely, this bus-bar 6C is shaped by bending the unfolded metal plate 7B in FIG. 9 in the same direction along broken lines A and B to form lateral planar regions 6y at both ends of the upright planar region 6x, and bending the upright planar region 6x in the same direction at the broken lines C and D to point the connecting terminals 6a at the ends of the lateral planar regions 6y in the same direction. Specifically, when viewed from above, the bus-bar 6C shown in FIG. 10 has reflection symmetry about an axis parallel to the connecting terminals 6a and passing through the center of the upright planar region 6x. This type of structure, which forms bus-bars 6B, 6C having connecting terminals 6a with different orientations from metal plate 7B with the same shape, has the characteristic that different types of bus-bars 6B, 6C can be manufactured in quantity while reducing production cost. In the bus-bar 6C shown in FIG. 10 as well, the radius of curvature (r3) of the bends made at broken lines C and D (in FIG. 9) are made larger than the radius of curvature (r1) of the bends made at broken lines A and B (in FIG. 9) to improve absorption of lateral vibration.

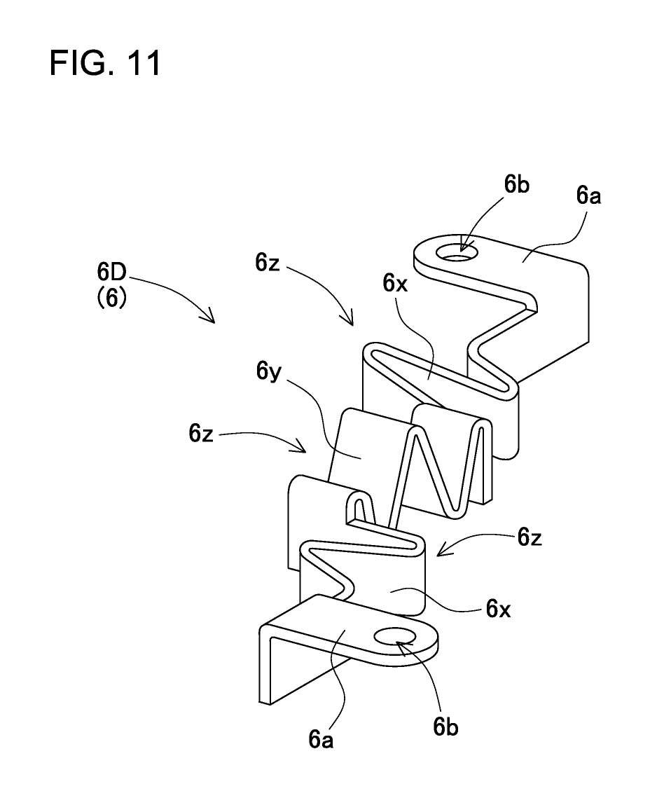

Further, the bus-bar 6D shown in FIG. 11 is provided with zigzag regions 6z by bending the metal plate in zigzag (accordion) shapes. Both the upright planar regions 6x and the lateral planar region 6y of this bus-bar 6D have zigzag (accordion) folds to establish zigzag regions 6z. However, the zigzag regions can also be established only in the upright planar regions or only in the lateral planar region.

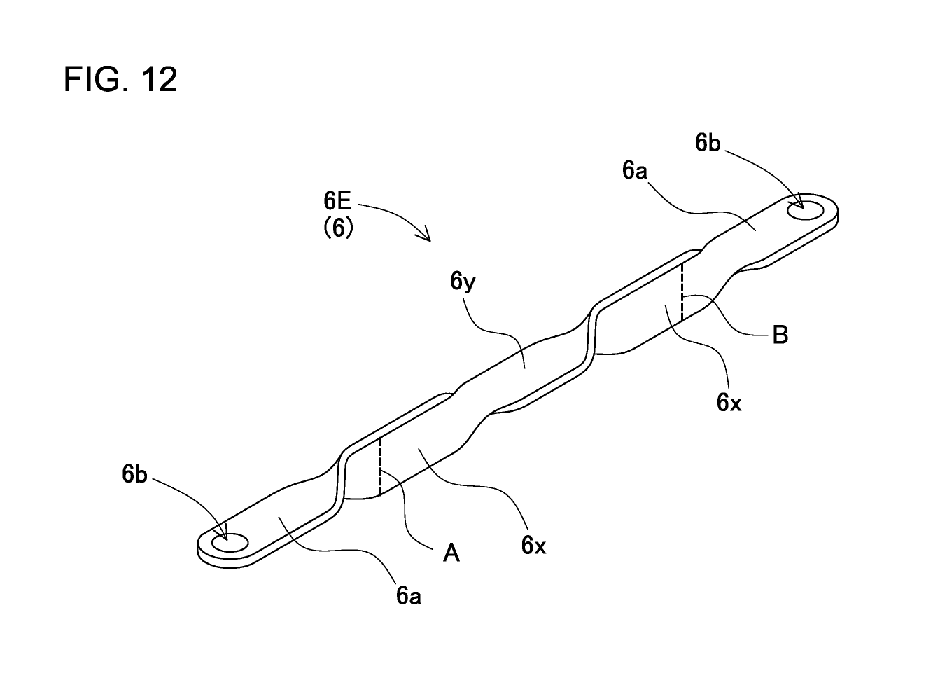

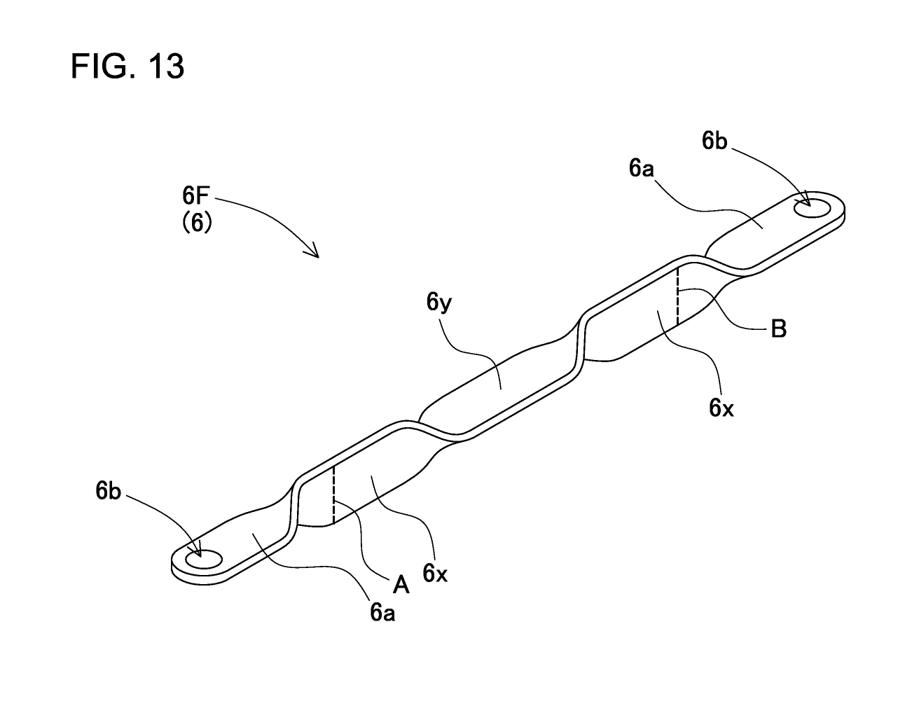

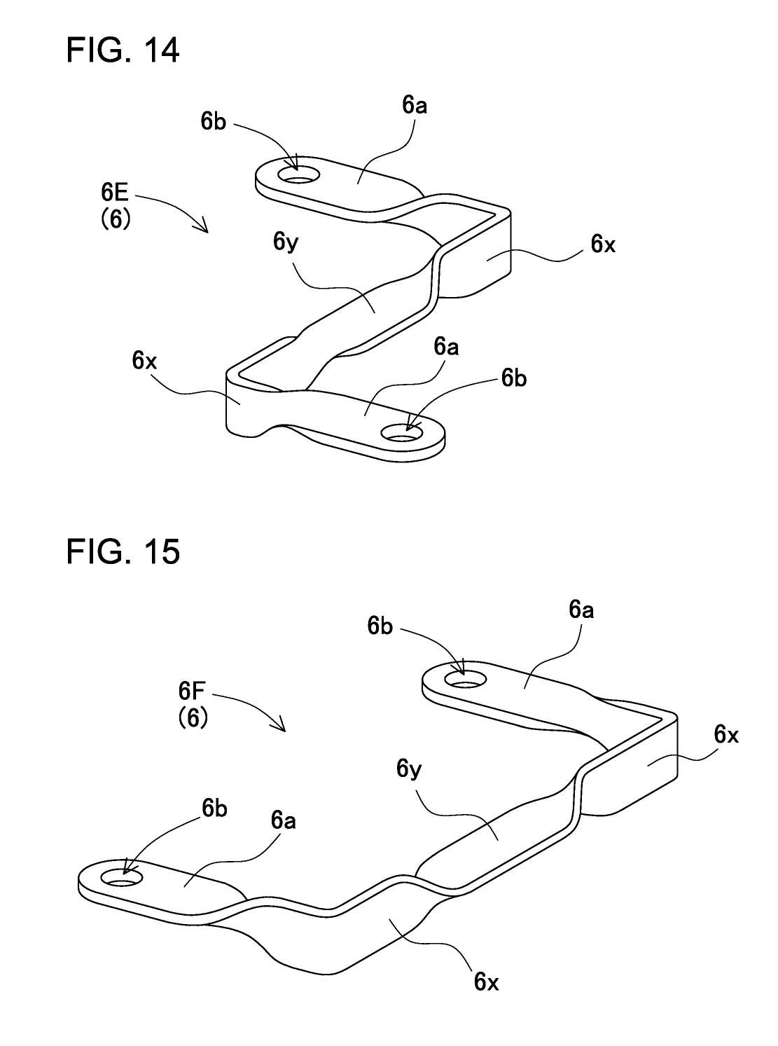

Still further, the bus-bars 6E, 6F shown in FIGS. 12 and 13 are formed with connected alternating upright planar regions 6x and a lateral planar region 6y by bending metal plate in a twisting manner. These bus-bars 6E, 6F are manufactured by cutting straight metal plate of a given width and forming bends by twisting. The bus-bar 6E shown in FIG. 12 is formed with connected alternating upright planar regions 6x and a lateral planar region 6y by bending metal plate into a spiral shape. The bus-bar 6E shown in FIG. 13 is formed with connected alternating upright planar regions 6x and a lateral planar region 6y by twisting segments of the metal plate (in opposite directions) to form the upright planar regions 6x. As shown in FIGS. 14 and 15, since these bus-bars 6E, 6F are formed with connected alternating upright planar regions 6x and a lateral planar region 6y, they can be freely reshaped by bending to connect the connecting terminals 6a at both ends to battery units 2. The bus-bars 6E, 6F shown in FIGS. 14 and 15 have their upright planar regions 6x bent at right angles along the broken lines A and B (in FIGS. 12 and 13) to dispose the connecting terminals 6a in a given direction. The bus-bar 6E in FIG. 14 has its connecting terminals 6a pointing in opposite directions while the bus-bar 6F in FIG. 15 has connecting terminals 6a pointing in the same direction.

As shown in FIG. 2, the connecting terminals 6a at the ends of the bus-bars 6 described above are connected to output terminals of adjacent battery units 2 to electrically connect the battery units 2. Bus-bars 6A, 6B, 6D, 6E shown in FIGS. 4, 5, 7, 8, 11, and 14 have connecting terminals 6a that point in opposite directions. These bus-bars 6A, 6B, 6D, 6E are appropriate for connecting adjacent battery units 2 disposed in the same row in FIG. 2. In the case of the power source apparatus shown in FIG. 2, adjacent battery units 2 in the same row are connected by the bus-bar 6A shown in FIGS. 4 and 5. Bus-bars 6C, 6F shown in FIGS. 10 and 15 have connecting terminals 6a that point in the same direction at both ends. These bus-bars 6C, 6F are appropriate for connecting adjacent battery units 2 disposed in adjacent rows in FIG. 2. In the case of the power source apparatus shown in FIG. 2, adjacent battery units 2 in adjacent rows are connected by the bus-bar 6C shown in FIG. 10. However, the shape of the bus-bars that connect the battery units can be changed in various ways depending on circumstances such as the number and arrangement of the battery units, the number of battery cells in each battery unit, and the types of battery cell connections in each battery unit.

Each battery unit 2 that is connected in series or parallel by bus-bars 6 has a plurality of battery cells 1 stacked together and connected in series. Although this type of battery unit 2 increases output voltage by connecting the battery cells 1 in series, battery cells can also be connected in parallel or in series and parallel.

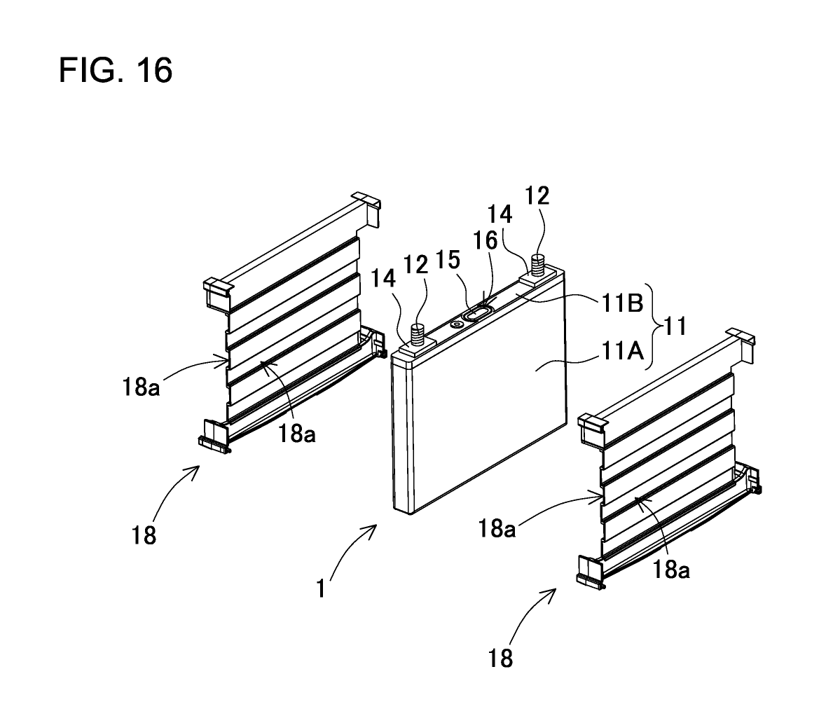

As shown in FIG. 16, a battery cell 1 is a rectangular lithium ion battery. However, any battery that can be charged such as a nickel hydride battery or nickel cadmium battery can be used as a battery cell. Although not illustrated, a battery cell 1 has an electrode unit, which is positive and negative electrode plates layered with intervening separators, held in a case 11 filled with electrolyte. In addition, the battery cell 1 case 11 can also house a current interrupt device. The current interrupt device changes shape (distorts) to separate electrical contacts and cut-off current flow when battery cell 1 internal pressure exceeds a set value.

A battery cell 1 case 11 is fabricated by shaping sheet-metal or hard plastic. A metal case 11 is made from aluminum, aluminum alloy, iron or steel. The metal case 11 is made up of a closed-bottom cylindrical external case 11A that is press-formed from bendable sheet-metal, and the open end of the external case 11A is sealed closed in an airtight manner by a sealing plate 11B. The sealing plate 11B is attached to the external case 11A by a method such as laser-welding. The external case 11A is formed in the shape of a rectangular cylinder having opposing rectangular planar surfaces, or is formed in the shape of a cylinder with U-shaped regions connecting both sides of the two primary opposing surfaces. The sealing plate 11B has positive and negative electrode terminals 12 mounted at the end regions of its upper surface that pass through the sealing plate 11B in an airtight and insulating manner via insulating material 14.

In addition, the sealing plate 11B that closes-off the open end of the external case 11A is provided with a safety valve 15 opening 16. If pressure inside the case 11 exceeds a set value, the safety valve 15 opens to prevent damage to the case 11. In a battery cell housing a current interrupt device, the internal battery pressure that results in safety valve 15 opening is set higher than the internal pressure that causes the current interrupt device to cut-off current. Specifically, if battery cell internal pressure rises and exceeds the pressure for current cut-off, the current interrupt device cuts-off the battery cell current. In that state, the current is cut-off and battery cell safety is secured. If battery cell internal pressure continues to rise after current cut-off by the current interrupt device and exceeds the pressure for opening the safety valve, the safety valve opens. If the safety valve opens, internal gas escapes to the outside through the opening in the sealing plate.

The battery cell 1 in FIG. 16 has a safety valve 15 opening 16 established in the sealing plate 11B. This type of battery cell 1 can discharge gas through the opening 16 of an open safety valve 15. This is because gas accumulates in the upper part of the inside the case 11. The safety valve opening could also be established in a side or bottom of the battery cell, However, in that type of battery cell, electrolyte would be discharged when the safety valve opened. Electrolyte is a conducting liquid, and if it is discharged, it can short circuit materials that it comes in contact with. A battery cell 1 with the safety valve 15 established on the sealing plate 11B can reduce internal pressure by discharging gas from an open safety valve 15. Accordingly, when the safety valve 15 opens, electrolyte discharge is limited reducing detrimental effects due to electrolyte seepage.

Although not illustrated, the power source apparatus is provided with gas exhaust ducts on top of the battery units 2 to exhaust gas discharged from the safety valves 15 to the outside. These gas exhaust ducts have openings on the underside that connect with safety valve 15 openings 16 to exhaust gas discharged from the safety valves 15 to the outside of the power source apparatus. This type of structure can quickly exhaust gas to the outside if it is discharged from a battery cell 1 with an open safety valve.

Battery cells 1 are rectangular cells having significant width relative to thickness, and battery cells 1 are stacked with primary opposing rectangular surfaces facing each other to make a battery unit 2. Adjacent electrode terminals 12 of the stacked battery cells 1 are connected with terminal connectors 21 for series connection. The battery units 2 shown in FIGS. 2 and 3 have adjacent battery cell 1 positive and negative electrode terminals 12 connected in series via terminal connectors 21. Battery cell 1 electrode terminals 12 are studs that are rod-shaped with a threaded surface, and nuts 22 are threaded onto those studs and tightened to attach the terminal connectors 21. Further, lead-wires (not illustrated) are connected to the electrode terminals 12 of each battery cell 1. The lead-wires are connected to a circuit board (not illustrated) carrying protection circuitry that detects battery cell 1 voltage. Although not illustrated, circuit boards are disposed in the upper part of the power source apparatus.

As shown in FIGS. 3 and 16, spacers 18 are sandwiched between stacked battery cells 1. In addition to insulating adjacent battery cell 1 external cases 11A, the spacers 18 establish cooling gaps 19 between the battery cells 1. Accordingly, spacers 18 are fabricated by molding insulating material such as plastic. A spacer 18 has ventilating grooves 18a formed on both sides that establish the cooling gaps 19 between the spacer 18 and the battery cells 1. A spacer 18 is provided with ventilating grooves 18a extending in the horizontal direction, which is in a direction that joins the two ends of a battery cell 1. Air is passed in a horizontal direction through the cooling gaps 19 established by the spacers 18 to cool the battery cells 1.

The battery cells 1 stacked with intervening spacers 18 are held in fixed positions by fastening components 3. Fastening components 3 are made up of a pair of endplates 4 disposed at both end planes of the battery cell 1 stack, and fastening bands 5 with ends connected to the endplates 4 to hold the stacked battery cells 1 in a compressed state. A battery unit 2 has fastening bands 5 connected to the pair of endplates 4 to hold the stack of battery cells 1 together with pressure applied in a direction perpendicular to opposing surfaces of the battery cells 1.

The endplates 4 are made of hard plastic that is molded, or are made of a metal such as aluminum or aluminum alloy. Each endplate 4 in FIGS. 2 and 3 has a plastic body 4A that is reinforced by a reinforcing metal piece 4B attached to the outer side. The fastening bands 5 attach to the reinforcing metal pieces 4B of the endplates 4. This configuration has the characteristic that endplates 4 are reinforced by reinforcing metal pieces 4B achieving a robust structure and the fastening bands 5 can be solidly connected to the endplates 4. In particular, this configuration has the characteristic that the endplate body 4A is molded from plastic and in itself has a sturdy structure. Accordingly, it is not always necessary to reinforce the endplates with reinforcing metal pieces. Further, although not illustrated, each plastic endplate body is also reinforced by horizontal and vertical reinforcing ribs formed on the outer side in single-piece construction with the endplate. This type of endplate body 4A has high bending strength. Endplates 4 with enhanced bending strength can effectively prevent expansion of battery cell 1 center regions. This is because as long as the endplates 4 connected by the fastening bands 5 do not bend or warp, the center region of the battery cells 1 will not expand.

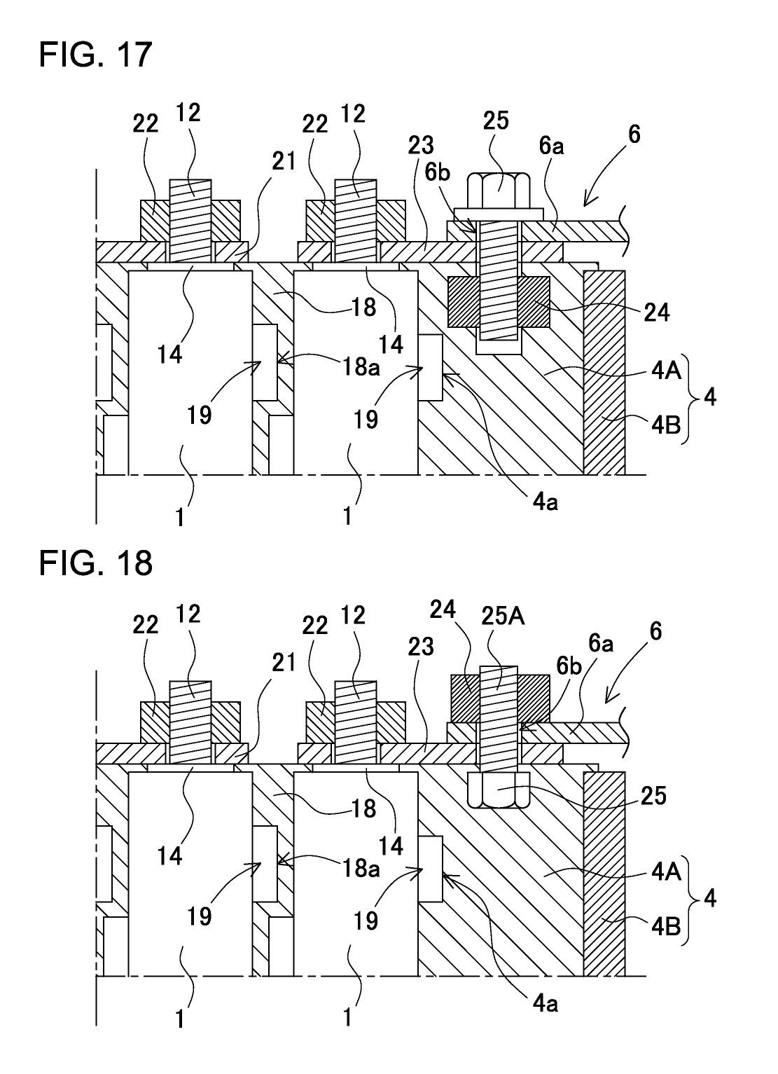

To hold the battery cells 1 over a wide area, the endplates 4 have the same rectangular outline as the battery cells 1. The rectangular endplates 4 are made the same size as the battery cells 1 or are made slightly larger than the battery cells 1. The endplates 4 in FIGS. 17 and 18 are provided with ventilating grooves 4a that establish cooling gaps 19 between the endplates 4 and the battery cells 1. However, the endplates can also have planar surfaces facing the battery cells, and those planar surfaces can be put in surface contact with adjacent battery cells or spacers. Plastic endplates are directly stacked with the battery cells while metal endplates are stacked with intervening stacking material.

The ends of the fastening bands 5 connect to the endplates 4. The fastening bands 5 connect to the endplates 4 via set-screws 29, or the end regions of the fastening bands can bend inward for endplate attachment, or nuts can be screwed onto the ends of the fastening bands, or the end regions of the fastening bands can be crimp-attached to the endplates. Endplates 4 connected by fastening bands 5 via set-screws 29 are provided with screw-holes that accept set-screw 29 insertion. The screw-holes are established in the outer surfaces of the endplates 4, and set-screws 29 inserted through bent regions 5A at the ends of the fastening bands 5 screw into the screw-holes to connect the fastening bands 5. The battery units 2 in FIG. 3 have endplates 4 connected by fastening bands 5 that traverse along the tops and bottoms of the rectangular battery cells 1. Each of the endplates 4 is provided with screw-holes at the top and bottom of the outer surface on both sides.

The fastening bands 5 are made from sheet-metal of a given thickness formed with a given width. The ends of the fastening bands 5 connect to the endplates 4 to retain the battery cells 1 in a compressed state between the pair of endplates 4. The fastening bands 5 fix the dimension between a pair of endplates 4 to hold the battery cells 1 stacked between the endplates 4 in a given state of compression. For example, the fastening bands 5 are made from sheet-metal such as SUS304 stainless-steel sheet-metal or other steel sheet-metal formed with a thickness and width that achieves sufficient strength. The fastening bands can also be made by forming sheet-metal in a channel-shape (with a u-shaped cross-section). Since fastening bands with this shape have good bending strength, they are characterized by the ability to solidly retain a stack of rectangular battery cells in a given state of compression while making the fastening bands narrower.

The ends of the fastening bands 5 are provided with bent regions 5A, and the bent regions 5A connect to the endplates 4. The bent regions 5A are provided with through-holes for the set-screws 29, and the fastening bands 5 are attached to the endplates 4 via set-screws 29 inserted through the through-holes.

In the power source apparatus of FIGS. 2 and 3, bus-bars 6 that connect the battery units 2 do not connect directly to a battery cell 1 electrode terminal 12, but rather connect to the electrode terminal 12 via an extension connector 23. As shown in FIGS. 3 and 17, an extension connector 23 is a metal plate that connects at one end to the electrode terminal 12 that serves as the battery unit 2 output terminal and connects at the other end to a bus-bar 6 connecting terminal 6a. The connecting terminal 6a of a bus-bar 6 connects to an extension connector 23 via a bolt 25 and a nut 24 that threads onto the bolt 25. The nut 24 in the endplate 4 of FIG. 17 is held in a manner that prevents its rotation. The nut 24 is insertion molded into the plastic endplate 4 during the endplate 4 molding process. However, the nut can also be held without rotating by fitting it into a cavity established to prevent rotation. The endplates 4 in FIG. 2 are molded with nuts 24 inserted in the side of each endplate 4 that connects with a bus-bar 6, which is the side of the endplate 4 next to the electrode terminal 12 that serves as the battery unit 2 output terminal. However, an endplate can also be provided with nuts embedded in positions corresponding to electrode terminals at both ends of the adjacent battery cell. In that case, an extension connector and bus-bar can be connected at the nut on either side of an endplate regardless of the position of the electrode terminal serving as the battery unit output terminal.

As shown in FIG. 17, a bolt 25 passes through the end of an extension connector 23, which has its other end connected to the electrode terminal 12 serving as the battery unit 2 output terminal, and the connecting terminal 6a of a bus-bar 6, and screws into a nut 24 to electrically connect the extension connector 23 and bus-bar 6 while holding them in a fixed position. Accordingly, each extension connector 23 is shaped to allow it to attach at one end to an output electrode terminal 12 and to attach at the other end to a nut 24 embedded in an endplate 4. Each extension connector 23 is provided with through-holes at the locations of the electrode terminal 12 and the endplate 4 nut 24.

The power source apparatus described above is configured with a nut 24 mounted in non-rotating manner in an endplate 4, and a bolt 25 is screwed into the nut 24 to connect a bus-bar 6 and extension connector 23. However, as shown in FIG. 18, a bolt 25 can be mounted in the endplate 4 instead of a nut 24. This type of endplate 4 is formed by insertion molding the bolt 25 in the endplate 4. The bolt 25 is embedded in the endplate 4 with the threaded rod portion of the bolt 25A protruding out the top. In this structure, a nut 24 is threaded onto the bolt 25 to connect an extension connector 23 and bus-bar 6 connecting terminal 6a and hold them in place on the endplate 4. The bolt 25 that the nut 24 is threaded onto has its threaded portion 25A inserted through an extension connector 23 through-hole and a bus-bar 6 connecting terminal 6a to stack the bus-bar 6 on top of the extension connector 23. Specifically, the extension connector 23 and connecting terminal 6a are stacked onto the bolt 25 embedded in the top of the endplate 6, and the nut 24 is screwed on to connect the connecting terminal 6a to the extension connector 23 and hold them in place on the endplate 4. When the nut 24 is tightened, the connecting terminal 6a is held to prevent rotation. With this structure as well, a bus-bar 6 connecting terminal 6a is connected via an extension connector 23 to the electrode terminal 12 serving as the battery unit 2 output terminal.

The power source apparatus described above has a plurality of battery units 2 housed in an external casing 9. The external casing 9 is made up of a lower case 9A and an upper case (not illustrated). The power source apparatus has a plurality of battery units 2 mounted in rows and columns on the base-plate 9a in the lower case 9A. The power source apparatus of the figures holds four battery units 2 on top of the base-plate 9a in two adjacent rows with each row having two battery units 2 arranged in a straight-line. The two rows of battery units 2 are disposed in a separated manner allowing air ducts to be established on both sides and in between the rows.

The power source apparatus described above forcibly ventilates the battery cells 1 by passing a coolant gas such as air through the cooling gaps 19 formed between adjacent battery cells 1. Although not illustrated, this type of power source apparatus has cooling ducts established on opposite sides of the cooling gaps 19 and coolant gas is forced to flow through the cooling ducts and cooling gaps 19 to cool the battery cells 1. However, battery cells in the power source apparatus battery units can also be cooled by disposing a cooling plate that is forcibly cooled with coolant (or refrigerant) at the bottom of the battery units, providing a cooling mechanism to cool the cooling plate, and cooling the battery cells from below via the cooling plate. In this type power source apparatus, it is not always necessary to establish cooling gaps with spacers.

The power source apparatus described above can be used as a power source on-board a vehicle. An electric powered vehicle such as a hybrid vehicle driven by both an engine and an electric motor, a plug-in hybrid vehicle, or an electric vehicle driven by an electric motor only can be equipped with the power source apparatus and use it as an on-board power source.

### (Power Source Apparatus in a Hybrid Vehicle Application)

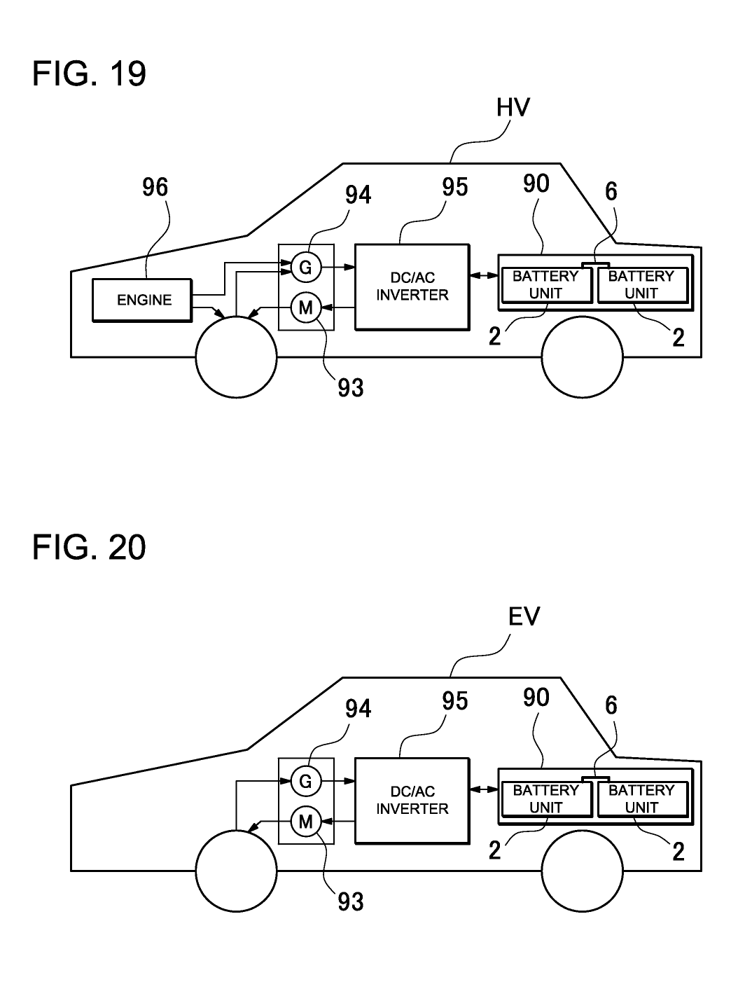

FIG. 19 shows an example of power source apparatus installation on-board a hybrid vehicle, which is driven by both an engine and an electric motor. The vehicle HV equipped with the power source apparatus 90 shown in this figure is provided with an engine 96 and a driving motor 93 to drive the vehicle HV, a power source apparatus 90 to supply power to the motor 93, and a generator 94 to charge the power source apparatus 90 batteries. The power source apparatus 90 is connected to the motor 93 and generator 94 via a DC/AC inverter 95. The vehicle HV runs on both the motor 93 and engine 96 while charging the batteries in the power source apparatus 90. In operating modes where engine efficiency is poor such as during acceleration and low speed cruise, the vehicle is driven by the motor 93. The motor 93 operates on power supplied from the power source apparatus 90. The generator 94 is driven by the engine 96 or by regenerative braking when the vehicle brake pedal is pressed and operates to charge the power source apparatus 90 batteries.

### (Power Source Apparatus in an Electric Vehicle Application)

FIG. 20 shows an example of power source apparatus installation on-board an electric vehicle, which is driven by an electric motor only. The vehicle EV equipped with the power source apparatus 90 shown in this figure is provided with a driving motor 93 to drive the vehicle EV, a power source apparatus 90 to supply power to the motor 93, and a generator 94 to charge the power source apparatus 90 batteries. The power source apparatus 90 is connected to the motor 93 and generator 94 via a DC/AC inverter 95. The motor 93 operates on power supplied from the power source apparatus 90. The generator 94 is driven by energy from regenerative braking and operates to charge the power source apparatus 90 batteries.

### (Power Source Apparatus in a Power Storage Application)

Further, application of the power source apparatus of the present invention is not limited to the power source for the driving motor in a vehicle. The power source apparatus of the present invention can also be used as the power source in a power storage apparatus that stores power by charging batteries with power generated by methods such as solar power or wind power generation. Or, the power source apparatus can be used as the power source in a power storage apparatus that stores power by charging batteries with late-night (reduced-rate) power. A power source apparatus charged by late-night power is charged by surplus power generated by the power plant late at night, and outputs power during the daytime when demand is high. This allows daytime peak-power usage to be limited. The power source apparatus can also be used as a power source that is charged by both solar cell output and late-night power. This type of power source apparatus effectively uses both late-night power and power generated by solar cells, and can take weather conditions and power consumption patterns into consideration to efficiently store power.

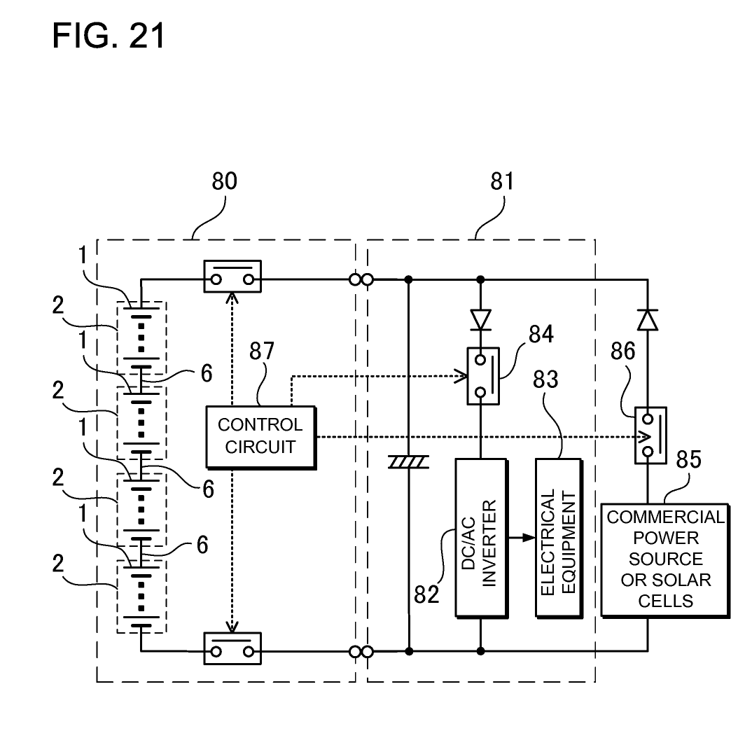

The power storage apparatus shown in FIG. 21 charges power source apparatus 80 batteries with a charging power supply 85 such as a (late-night) commercial power source or solar cells, and discharges power source apparatus 80 batteries to supply power to the DC/AC inverter 82 of a load 81. Accordingly, the power storage apparatus of the figure has a charging mode and a discharging mode. The charging power supply 85 is connected to the power source apparatus 80 via a charging switch 86, and the DC/AC inverter 82 is connected to the power source apparatus 80 via a discharge switch 84. The discharge switch 84 and the charging switch 86 are controlled ON and OFF by a power source apparatus 80 control circuit 87. In the charging mode, the control circuit 87 switches the charging switch 86 ON and the discharge switch 84 OFF to charge the power source apparatus 80 batteries with power supplied from the charging power supply 85. When power source apparatus 80 charging is completed by fully-charging the batteries or by charging to a battery capacity at or above a given capacity, the control circuit 87 switches the charging switch 86 OFF to stop charging. In the discharging mode, the control circuit 87 switches the discharge switch 84 ON and the charging switch 86 OFF to supply power from the power source apparatus 80 to the load 81. The load 81 that is supplied with power from the power source apparatus 80 delivers that power to electrical equipment 83 via the DC/AC inverter 82. When power source apparatus 80 remaining battery capacity drops to a given capacity, the control circuit 87 switches the discharge switch 84 OFF to stop battery discharge. Depending on requirements, the power storage apparatus can also turn ON both the charging switch 86 and the discharge switch 84 to allow power to be simultaneously supplied to the load 81 while charging the power source apparatus 80.

### INDUSTRIAL APPLICABILITY

The power source apparatus of the present invention can be appropriately used as a power source apparatus in a vehicle such as a plug-in hybrid electric vehicle that can switch between an electric vehicle mode and a hybrid vehicle mode, a hybrid (electric) vehicle, and an electric vehicle. The present invention can also be appropriately used in applications such as a server computer backup power source that can be rack-installed, a backup power source apparatus for a wireless base station such as a mobile phone base station, a power storage apparatus for the home or manufacturing facility, a streetlight power source, a power storage apparatus for use with solar cells, and a backup power source in systems such as traffic signals. It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2011-154179 filed in Japan on Jul. 12, 2011, the content of which is incorporated herein by reference.

What is claimed is:

1. A power source apparatus comprising:
battery units made up of a plurality of connected battery cells; and
bus-bars that connect the battery units in series or parallel,
wherein each bus-bar is metal plate formed with mutually perpendicular upright planar region(s) and lateral planar region(s) connected between connecting terminals at both ends, and
lateral and up and down relative vibration between battery units connected to the connecting terminals is absorbed by the upright planar region(s) and lateral planar region(s).

2. The power source apparatus as cited in claim 1 wherein each bus-bar is formed with upright planar regions joined to both ends of a lateral planar region, and the ends of the upright planar regions are joined to the lateral planar region and the connecting terminals, which lie in planes parallel to the lateral planar region.

3. The power source apparatus as cited in claim 1 wherein each bus-bar is bent to form it into a zigzag shape having zigzag regions.

4. The power source apparatus as cited in claim 1 wherein each bus-bar is rotationally bent in a twisting manner to form alternating upright planar region(s) and lateral planar region(s).

5. The power source apparatus as cited in claim 1 wherein the bus-bars are any of the metals such as copper, copper alloy, silver, or silver alloy.

6. The power source apparatus as cited in claim 1 provided with an external casing that holds a plurality of battery units, and the battery units are mounted on a base-plate in the external casing.

7. The power source apparatus as cited in claim 1 used as the power source to supply electric power to a motor that drives a vehicle.

8. A vehicle equipped with the power source apparatus cited in claim 1.
